(19) United States
(12) Patent Application Publication
(10) Pub. No.: US 2008/0116811 A1
(43) Pub. Date: May 22, 2008

(54) Plasma display device and power supply

(76) Inventor: Il-Woon Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/879,638

(22) Filed: Jul. 17, 2007

(30) Foreign Application Priority Data
Nov. 20, 2006 (KR) 10-2006-0114689

(51) Int. Cl. G09G 3/10; G06F 1/04

(52) U.S. Cl. 315/169.4; 327/295

(57) ABSTRACT

A plasma display device and a power supply, having advantages of performing a normal AC voltage detection operation regardless of a peripheral temperature is disclosed. The use of passive elements allows for temperature invariance.

### CROSS-REFERENCE TO RELATED APPLICATION

This application claims priority to and the benefit of Korean Patent Application No. 10-2006-0114689 filed in the Korean Intellectual Property Office on Nov. 20, 2006, the entire content of which is incorporated herein by reference.

### BACKGROUND

1. Field

The field relates to a plasma display device and a power supply.

2. Description of the Related Technology

A plasma display device is a display device that displays characters or images using plasma generated by gas discharge. Depending on its size, the plasma display panel includes more than several scores to millions of pixels arranged in a matrix. The plasma display device is categorized as a DC type or an AC type according to a driving voltage waveform and a discharge cell structure.

In a panel for a DC type plasma display device, since electrodes are exposed to a discharge space, while a voltage is applied, a current flows in the discharge space. Therefore, such a DC type plasma display device problematically requires a resistance for limiting the current. Meanwhile, in a panel for an AC type plasma display device, electrodes are covered with a dielectric layer, the current is limited by a natural capacitance component, and the electrodes are protected from ion impact upon discharge by the dielectric layer. Accordingly, the AC type has an advantage of having longer lifespan than the DC type.

Such a plasma display device includes a power supply that supplies various high voltages required for plasma discharge, for example, a sustain discharge voltage Vs, an address voltage Va, a reset voltage Vset, and a scan voltage, to a driving circuit, and supplies low voltages to other circuit units, that is, an image processing unit, a fan, an audio unit, a control circuit unit, and the like.

In general, the power supply is implemented with a switching mode power supply, and includes an AC voltage detection circuit that detects whether or not an AC to the switching mode power supply.

FIG. 1 is a diagram showing a general AC voltage detection circuit.

As shown in FIG. 1, the general AC voltage detection circuit 10 includes a resistor R, one end of which is an AC voltage input terminal, to which an AC voltage is input, a photo diode PC1, an anode of which is connected to the other end of the resistor R and a cathode of which is connected to a ground terminal, and a photo transistor PC2, a collector of which is connected to a power source Vcc supplying a Vcc voltage and which forms a photo coupler PC together with the photo diode PC1. The AC voltage detection circuit 10 outputs a detection voltage Vdet in proportion to the input AC voltage through an emitter of the photo transistor PC2.

However, since a current transfer ratio (CTR) decreases as a peripheral temperature of the plasma display device increases, the photo coupler PC in the general AC voltage detection circuit 10 has a trouble in performing a normal AC voltage detection operation.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a plasma display device including a plasma display panel having a plurality of discharge cells, a driver configured to drive the plasma display panel, and a power supply configured to transform a varying voltage input signal, to supply a plurality of generated voltages to the driver, and to detect a voltage level of the varying voltage input signal using a voltage detection circuit, where the voltage detection circuit includes a voltage converter configured to generate a first signal by clamping a voltage higher than a breakdown voltage from the varying voltage input signal, the varying voltage input signal varying relative to a first voltage between a second and a third voltage, and to generate a second signal substantially without a DC bias component from the first signal, and an output unit configured to output a third signal, the third signal being proportional to the second signal.

Another aspect is a power supply configured to transform a varying voltage input signal and to generate a plurality of voltages, the power supply including an AC voltage detection circuit configured to detect a voltage level of the varying voltage input signal, where the AC voltage detection circuit includes a voltage converter configured to generate a first signal by clamping a voltage higher than a breakdown voltage from the varying voltage input signal, the varying voltage input signal varying relative to a first voltage between a second and a third voltage, and to generate a second signal substantially without a DC bias component from the first signal, and an output unit configured to output a third signal, the third signal being proportional to the second signal.

Another aspect is a plasma display device, including a plasma display panel having a plurality of discharge cells, a driver configured to drive the plasma display panel according to input signals, and an input circuit configured to receive signals and to generate at least one of the input signals, the input circuit including a transformer, whereby the received signal is isolated from the at least one input signal.

### BRIEF DESCRIPTION OF THE DRAWINGS

FIG. 1 is a diagram showing a general AC voltage detection circuit.

FIG. 2 is a block diagram showing a plasma display device according to one embodiment.

FIG. 3 is a diagram showing an AC voltage detection circuit according to one embodiment.

FIG. 4 is a voltage waveform diagram showing voltage waveforms of individual units of the AC voltage detection circuit 610 according to one embodiment.

FIG. 5 is a diagram showing an AC voltage detection circuit according to another embodiment.

FIG. 6 is a voltage waveform diagram showing voltage waveforms of individual units of the AC voltage detection circuit according to one embodiment.

### DETAILED DESCRIPTION OF CERTAIN EMBODIMENTS

A plasma display device and a power supply, wherein certain embodiments have advantages of performing a normal AC voltage detection operation regardless of a peripheral temperature is disclosed.

In the following detailed description, only certain embodiments have been shown and described, simply by way of illustration. As those skilled in the art would realize, the described embodiments may be modified in various ways, all without departing from the spirit or scope of the present invention. Accordingly, the drawings and description are to be regarded as illustrative in nature and not restrictive.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising,” will be understood to imply the inclusion of stated elements but not the exclusion of any other elements.

The term “wall charges” used herein means charges formed on a wall close to each electrode of a discharge cell (for example, a dielectric material layer). Although the wall charges do not actually touch the electrodes, the wall charges will be described as being “formed” or “accumulated” on the electrode. The term “wall voltage” means a potential difference formed on the wall of the discharge cell by the wall charges.

In the specification, “maintaining a voltage” includes a voltage variation within the range allowable in the design even when a difference in potential between two specific points varies with time and a voltage variation caused by a parasitic component which can be neglected in the design in this technical field. Since a threshold voltage of a semiconductor device (for example, a transistor and a diode) is considerably lower than a discharge voltage, it is considered that the threshold voltage is approximately 0 V.

A plasma display device and a power supply according to one embodiment will now be described in detail with reference to the drawings.

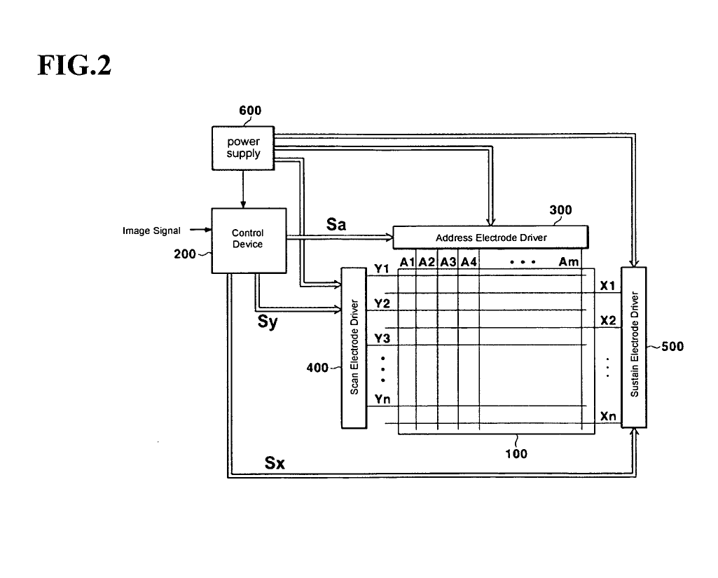

FIG. 2 is a block diagram showing a plasma display device according to one embodiment.

As shown in FIG. 2, a plasma display device according to one embodiment includes a plasma display panel (PDP) 100, a control device 200, an address electrode driver 300, a scan electrode driver 400, a sustain electrode driver 500, and a power supply 600.

The plasma display panel 100 is provided with a plurality of address electrodes A1 to Am extending in a column direction, and a plurality of sustain electrodes X1 to Xn and scan electrodes Y1 to Yn extending in a row direction in pairs. The sustain electrodes X1 to Xn are formed to correspond to the scan electrodes Y1 to Yn. The plasma display panel 100 has a substrate (not shown) on which the sustain electrodes X1 to Xn and the scan electrodes Y1 to Yn are arranged and a substrate (not shown) on which the address electrodes A1 to Am are arranged. The two substrates are disposed to face each other with a discharge space interposed therebetween such that the scan electrodes Y1 to Yn and the address electrodes A1 to Am, and the sustain electrodes X1 to Xn and the address electrodes A1 to Am are substantially perpendicular to each other. At this time, discharge spaces at intersections of the address electrodes A1 to Am, the sustain electrodes X1 to Xn, and the scan electrodes Y1 to Yn form discharge cells. The above-described structure of the plasma display panel 100 is just an example. For example, a panel having a different structure, to which driving waveforms described below can be applied, can be applied to the present invention.

The control device 200 receives a video signal from the outside and outputs an address electrode driving control signal Sa, a sustain electrode driving control signal Sx, and a scan electrode driving control signal Sy. The control device 200 performs driving by dividing each frame into a plurality of subfields. Each subfield includes a reset period, an address period, and a sustain period. Further, the control device 200 generates a high scan voltage Vscan_h, which is applied to cells to be not addressed in the address period, using a DC voltage supplied from the power supply 600 and supplies the generated high scan voltage to the scan electrode driver 400 or the sustain electrode driver 500.

The address electrode driver 300 receives the address electrode driving control signal Sa from the control device 200 and applies display data signals for selecting the discharge cells to the individual address electrodes.

The scan electrode driver 400 receives the scan electrode driving control signal Sy from the control device 200 and applies a driving voltage to the scan electrodes Y.

The sustain electrode driver 500 receives the sustain electrode driving control signal Sx from the control device 200 and applies a driving voltage to the sustain electrodes X.

The power supply 600 supplies voltages required for driving the plasma display device to the control device 200 and the individual drivers 300, 400, and 500.

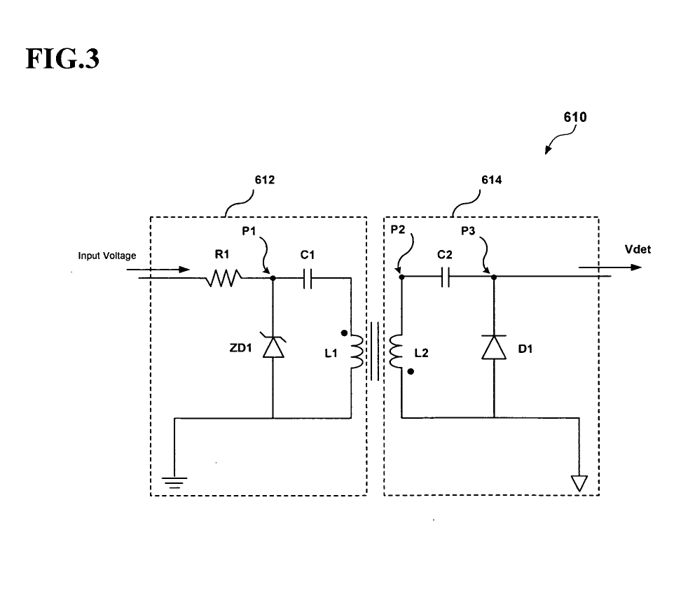

Hereinafter, an AC voltage detection circuit according to an exemplary embodiment of the present invention in the power supply 600 of FIG. 2 will be described with reference to FIGS. 3 to 6.

FIG. 3 is a diagram showing an AC voltage detection circuit according to one embodiment.

As shown in FIG. 3, the AC voltage detection circuit 610 includes a voltage converter 612 and an output unit 614.

The voltage converter 612 includes a resistor R1, one end of which is connected to an AC voltage input terminal, to which an AC voltage is input, a Zener diode ZD1, a cathode of which is connected to the other end of the resistor R1 and an anode of which is connected to a ground terminal, a capacitor C1, one end of which is connected to the other end of the resistor R1, and a primary coil L1 of a transformer, one end of which is connected to the other end of the capacitor C1 and the other end of which is connected to the ground terminal.

The output unit 614 includes a secondary coil L2 of the transformer, one end of which is connected to a ground terminal, a capacitor C2, one end of which is connected to the other end of the secondary coil L2 of the transformer and the other end of which is connected to an output terminal, through which the detection voltage Vdet is output, and a diode D1, one end of which is connected to the other end of the capacitor C2 and the other end of which is connected to one end of the secondary coil L2 of the transformer.

The voltage levels of the ground terminal of the voltage converter 612 and the ground terminal of the output unit 614 are generally set to be different from each other. Alternatively, the same voltage level may be set.

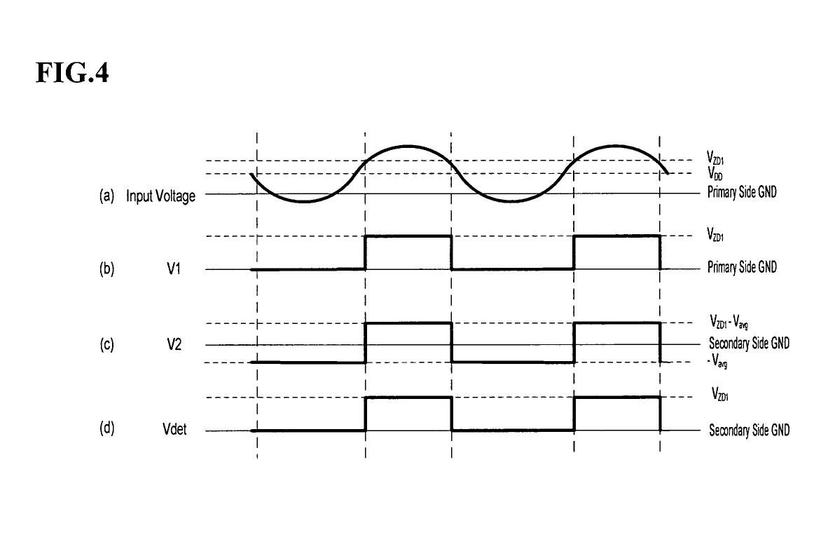

Hereinafter, driving of the AC voltage detection circuit 610 according to the embodiment shown in FIG. 3 will be described in detail with reference to FIG. 4. In the following description, it is assumed that a winding ratio of the primary coil L1 and the secondary coil L2 of the transformer is 1:1. Of course, the winding ratio of the primary coil L1 and the secondary coil L2 of the transformer may be set to a different ratio. Here, the fact the winding ratio of the primary coil L1 and the secondary coil L2 of the transformer is 1:1 means that the inductance values of the primary coil L1 and the secondary coil L2 are consistent with each other.

FIG. 4 is a voltage waveform diagram showing voltage waveforms of individual units of the AC voltage detection circuit 610 according to the embodiment.

First, FIG. 4 (a) shows an AC voltage that is input to the AC voltage detection circuit 610 according to the embodiment. As shown in FIG. 4 (a), the input AC voltage has a voltage waveform that swings by a level on a DC bias voltage V_{DD}.

FIG. 4 (b) shows a voltage V1 that is a voltage at a node P1. The Zener diode ZD1 has a unique breakdown voltage V_{ZD1}, and, when a voltage higher than the breakdown voltage V_{ZD1} is input to the cathode, the Zener diode ZD1 clamps the voltage. For this reason, as shown in FIG. 4 (b), the voltage V1 becomes a square wave. Specifically, a voltage higher than the breakdown voltage V_{ZD1} of the Zener diode ZD1 in the voltage waveform shown in FIG. 4 (a) is clamped to the breakdown voltage V_{ZD1} of the Zener diode ZD1, and a voltage lower than the breakdown voltage V_{ZD1} of the Zener diode ZD1 is substantially unaffected by the Zener diode ZD1.

Even though the input voltage falls by an amount in correspondence with resistance of the resistor R1, in the voltage waveform shown in FIG. 4 (b), a voltage drop by the resistor R1 is not shown.

FIG. 4 (c) shows a voltage V2 that is a voltage at a node P2. Since the capacitor C1 filters a DC component and transmits only an AC component, a voltage to be applied to the primary coil L1 of the transformer becomes a voltage that is obtained by subtracting a voltage Vavg as an average value of the voltage V1 from the voltage V1. If the winding ratio of the primary coil L1 and the secondary coil L2 of the transformer is 1:1, the voltage V2 that is induced in the secondary coil L2 is a square wave having a high value of the secondary side gnd plus V_{ZD1}-V_{avg} and a low value of the secondary side gnd minus V_{avg}.

FIG. 4 (d) shows a voltage at a node P3, that is, the voltage Vdet that is an output voltage of the output unit 614 (see FIG. 3).

The capacitor C2 is charged to a voltage with a current in a direction from the node P2 to the node P3 when the voltage V2 of FIG. 4 (c) has a positive value, and supplies a voltage to the node P3 through a current in a direction from the secondary coil L2 of the transformer to the diode D1 when the voltage V2 voltage has a negative value. Accordingly, the voltage to be induced from the primary coil L1 of the transformer to the secondary coil L2 is also supplied to the node P3. Capacitance of the capacitor C2 is set to compensate for the bias voltage V_{DD} filtered by the capacitor C1. For this reason, the voltage Vdet becomes a voltage higher than the voltage V2 by the voltage Vavg. That is, the voltage Vdet becomes a square wave, like the voltage V1 shown in FIG. 4 (b), relative to the voltage of the ground terminal of the output unit 614 on the secondary side of the transformer.

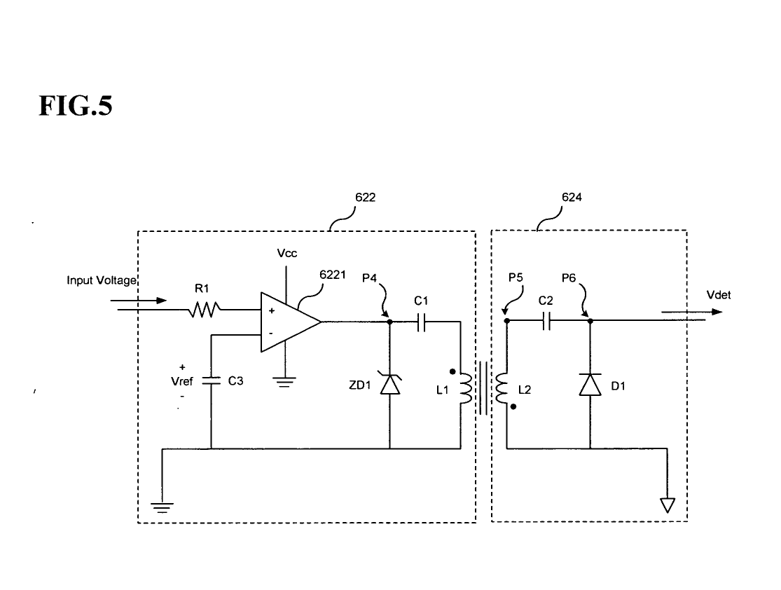

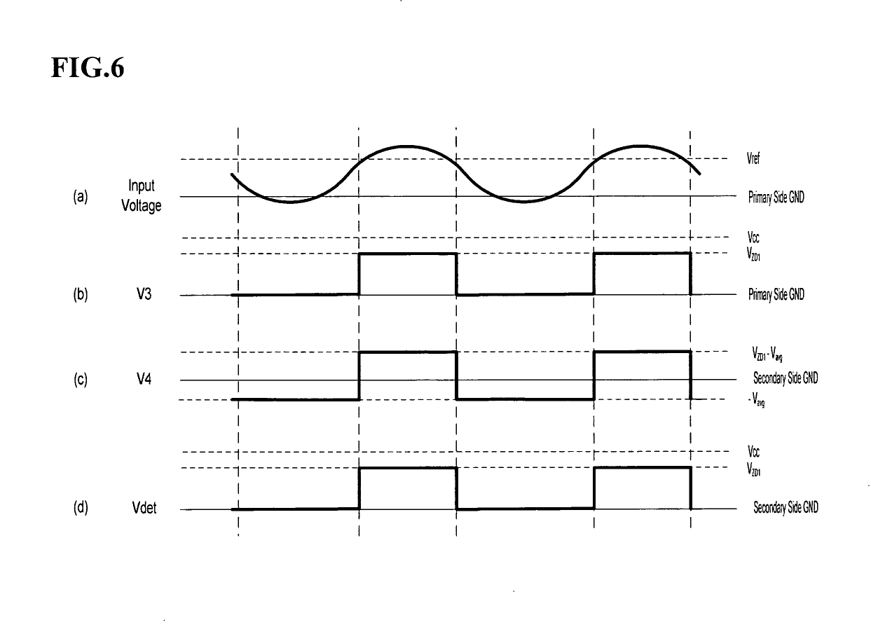

An AC voltage detection circuit according to an embodiment will be described with reference to FIGS. 5 and 6.

FIG. 5 is a diagram showing an AC voltage detection circuit according to an embodiment. The AC voltage detection circuit 620 according to the embodiment has similar parts as those in the AC voltage detection circuit 610 shown in FIG. 3. Accordingly, the descriptions of the some parts will be omitted, and differences will be described.

The AC voltage detection circuit 620 according to the embodiment shown in FIG. 5 includes a voltage converter 622. The voltage converter 622 includes a resistor R1, one end of which is connected to an AC voltage input terminal, to which an AC voltage is input, a capacitor C3, one end of which is connected to a ground terminal and which is charged with a reference voltage Vref, a comparator 6221, a non-inverting input terminal of which is connected to the other end of the resistor R1 and an inverting input terminal of which is connected to the other end of the capacitor C3, a capacitor C1, one end of which is connected to an output terminal of the comparator 6221, a Zener diode ZD1, a cathode of which is connected to one end of the capacitor C1 and an anode of which is connected to a ground terminal, and a primary coil L1 of a transformer, one end of which is connected to the other end of the capacitor C1 and the other end of which is connected to the anode of the Zener diode ZD1.

The voltage levels of the ground terminal of the voltage converter 622 and the ground terminal of the output unit 624 are generally set to be different from each other. Alternatively, the same voltage level may be set.

Hereinafter, driving of the AC voltage detection circuit 620 according to the embodiment shown in FIG. 5 will be described in detail with reference to FIG. 6. In the following description, it is assumed that the winding ratio of the primary coil L1 and the secondary coil L2 of the transformer is 1:1. Of course, the winding ratio of the primary coil L1 and the secondary coil L2 of the transformer may be set in a different manner. Here, the fact the winding ratio of the primary coil L1 and the secondary coil L2 of the transformer is 1:1 means that the inductance values of the primary coil L1 and the secondary coil L2 are consistent with each other.

FIG. 6 is a voltage waveform diagram showing voltage waveforms of individual units of the AC voltage detection circuit according to one embodiment.

FIG. 6 (a) shows the AC voltage that is input to the AC voltage detection circuit 620. The input AC voltage has a voltage waveform that swings by a level relative to the reference voltage Vref.

FIG. 6 (b) shows a voltage V3 that is a voltage at a node P4. The comparator 6221 (see FIG. 4) compares the AC voltage and the reference voltage that are respectively input to the non-inverting input terminal and the inverting input terminal. As the comparison result, the comparator 6221 outputs a voltage Vcc when the AC voltage is higher than the reference voltage Vref and outputs a ground voltage when the AC voltage is lower than the reference voltage Vref. If a voltage higher than a breakdown voltage V_{ZD1} of the Zener diode ZD1 is input to the cathode thereof, the Zener diode ZD1 clamps the voltage. Accordingly, the voltage Vcc output from the comparator 6221 falls to the breakdown voltage of the Zener diode ZD1, and thus the voltage V3 becomes a square wave having a voltage level with a maximum of the breakdown voltage of the Zener diode ZD1. The Vcc voltage may be set to a voltage higher than the breakdown voltage V_{ZD1} of the Zener diode ZD1.

FIG. 6 (c) shows a voltage V4 that is a voltage at a node P5. A bias voltage V_{DD} as a DC component included in the voltage V3 of FIG. 6 (b) is eliminated by the capacitor C1. Accordingly, the voltage to be applied to the primary coil L1 of the transformer becomes lower than the voltage V3 by a voltage Vavg as an average value of the voltage V3. If the winding ratio of the primary coil L1 and the secondary coil L2 of the transformer is 1:1, a voltage V4 that is a voltage induced in the secondary coil L2 is a square wave having a voltage level with a high value of the secondary side gnd plus V_{ZD1}-V_{avg} and a low value of the secondary side gnd minus V_{avg}.

FIG. 6 (d) shows a voltage at a node P6, that is, a voltage Vdet that is an output voltage of the output unit 624 (see FIG. 5).

The capacitor C2 is charged to a voltage with a current in a direction from the node P5 to the node P6 when the voltage V4 of FIG. 6 (c) has a positive value, and supplies a voltage to the node P6 through a current in a direction from the secondary coil L2 of the transformer to the diode D1 when the voltage V4 has a negative value. Accordingly, the voltage to be induced from the primary coil L1 of the transformer to the secondary coil L2 is also supplied to the node P6. Capacitance of the capacitor C2 is set to compensate for the bias voltage V_{DD} filtered by the capacitor C1. For this reason, the voltage Vdet becomes a voltage higher than the voltage V4 by the voltage Vavg. That is, the voltage Vdet becomes a square wave, like the voltage V3 shown in FIG. 6 (b), relative to the voltage of the ground terminal of the output unit 624 on the secondary side of the transformer.

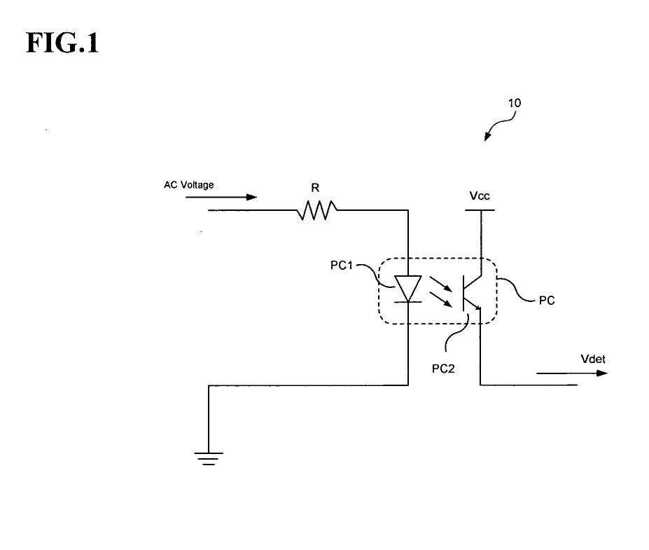

Unlike the general AC voltage detection circuit 10 shown in FIG. 1, the AC voltage detection circuit 610 or 620 includes passive elements insensitive to a change in peripheral temperature of the plasma display device. Accordingly, the AC voltage detection circuit 610 or 620 can perform a normal AC voltage detection operation regardless of the peripheral temperature.

Meanwhile, the above-described AC voltage detection circuit 610 or 620 according to some embodiments can be widely used in a power supply of a display device including a plasma display device or a liquid crystal display (LCD), or a general power supply.

As described above, according to the embodiments presented, an AC voltage detection circuit can be implemented using passive elements insensitive to a change in peripheral temperature of the plasma display device. As a result, a normal AC voltage detection can be performed regardless of a peripheral temperature.

While this invention has been described in connection with what is presently considered to be practical embodiments, it is to be understood that the invention is not limited to the disclosed embodiments, but, on the contrary, is intended to cover various modifications and equivalent arrangements.

What is claimed is:

1. A plasma display device comprising:
a plasma display panel, comprising a plurality of discharge cells;
a driver configured to drive the plasma display panel; and
a power supply configured to transform a varying voltage input signal, to supply a plurality of generated voltages to the driver, and to detect a voltage level of the varying voltage input signal using a voltage detection circuit,
wherein the voltage detection circuit comprises:
a voltage converter configured to generate a first signal by clamping a voltage higher than a breakdown voltage from the varying voltage input signal, the varying voltage input signal varying relative to a first voltage between a second and a third voltage, and to generate a second signal substantially without a DC bias component from the first signal, and
an output unit configured to output a third signal, the third signal being proportional to the second signal.

2. The plasma display device of claim 1, wherein the voltage converter further comprises:
a Zener diode, comprising:
a cathode connected to a signal input terminal configured to receive the varying voltage input signal; and
an anode connected to a first power source configured to supply a fourth voltage;
a first capacitor, connected to the cathode of the Zener diode; and
a first inductor, connected to the first capacitor and connected to the anode of the Zener diode.

3. The plasma display device of claim 2, wherein the second voltage is the breakdown voltage of the Zener diode.

4. The plasma display device of claim 2, wherein the output unit includes:
a second inductor cooperatively forming a transformer with the first inductor and connected to a second power source configured to supply a fifth voltage;
a second capacitor, connected to the second inductor and to an output terminal; and
a first diode, comprising:
a cathode connected to the second capacitor; and
an anode connected to the second inductor.

5. The plasma display device of claim 4, wherein the second signal is applied to the first inductor, and the third signal is obtained by adding a fourth signal to a sixth voltage, the fourth signal being induced at the second inductor by the first inductor, and the sixth voltage being stored in the third capacitor.

6. The plasma display device of claim 5, wherein inductance values of the first and second inductors are substantially the same, and the third signal is substantially equal to the first signal.

7. The plasma display device of claim 6, wherein the first, second, third and fourth signals comprise substantially square waves.

8. The plasma display device of claim 4, wherein the third, fourth, and fifth voltages are substantially ground voltages.

9. A power supply configured to transform a varying voltage input signal and to generate a plurality of voltages, the power supply comprising:
an AC voltage detection circuit configured to detect a voltage level of the varying voltage input signal,
wherein the AC voltage detection circuit comprises:
a voltage converter configured to generate a first signal by clamping a voltage higher than a breakdown voltage from the varying voltage input signal, the varying voltage input signal varying relative to a first voltage between a second and a third voltage, and to generate a second signal substantially without a DC bias component from the first signal, and
an output unit configured to output a third signal, the third signal being proportional to the second signal.

10. The power supply of claim 9, wherein the voltage converter includes:
a first capacitor connected to a first power source configured to supply a fourth voltage;
a comparator, comprising:
a non-inverting input terminal connected to a signal input terminal configured to receive the varying voltage input signal; and
an inverting input terminal connected to the first capacitor;
a Zener diode, comprising:
a cathode connected to an output terminal of the comparator; and
an anode connected to the first power source;
a second capacitor, connected to the cathode of the Zener diode; and
a first inductor, connected to the second capacitor and to the anode of the Zener diode.

11. The power supply of claim 10, wherein the second voltage is the breakdown voltage of the Zener diode.

12. The power supply of claim 10, wherein the comparator is configured to compare the varying voltage input signal and a fifth voltage, the fifth voltage charged in the first capacitor, and to generate a sixth voltage if the varying voltage input signal is greater than the fifth voltage and a seventh voltage if the varying voltage input signal is less than the fifth voltage.

13. The power supply of claim 12, wherein the sixth voltage is greater than the second voltage.

14. The power supply of claim 12, wherein the output unit includes:
a second inductor cooperatively forming a transformer with the first inductor and connected to a second power source configured to supply an eighth voltage;
a third capacitor, connected to the second inductor and to an output terminal; and
a first diode, comprising:
a cathode connected to the third capacitor; and
an anode connected to the second inductor.

15. The power supply of claim 14, wherein the second signal is applied to the first inductor, and the third signal is obtained by adding a fourth signal to a ninth voltage, the fourth signal being induced at the second inductor by the first inductor, and the ninth voltage being stored in the third capacitor. be induced from the first inductor to the second inductor and a ninth voltage to be charged in the third capacitor.

16. The power supply of claim 15, wherein inductance values of the first and second inductors are substantially the same, and the third signal is the substantially equal to the first signal.

17. The power supply of claim 16, wherein the first, second, third, and fourth signal are substantially square waves.

18. The power supply of claim 14, wherein the fourth voltage, the seventh voltage, and the eighth voltage are substantially ground voltages.

19. A plasma display device, comprising:
a plasma display panel, comprising a plurality of discharge cells;
a driver configured to drive the plasma display panel according to input signals; and
an input circuit configured to receive signals and to generate at least one of the input signals, the input circuit including a transformer, whereby the received signal is isolated from the at least one input signal.

20. The display device of claim 19, wherein the input circuit further comprises a Zener diode.
